(19) United States
(12) Patent Application Publication
(10) Pub. No.: US 2014/0018045 A1
(43) Pub. Date: Jan. 16, 2014

(54) TRANSCRIPTION DEVICE AND METHOD FOR TRANSCRIBING SPEECH

(71) Applicant: Metaswitch Networks Limited, Enfield (GB)

(72) Inventor: John Alexander Tucker, Hertfordshire (GB)

(21) Appl. No.: 13/939,078

(22) Filed: Jul. 10, 2013

(30) Foreign Application Priority Data
Jul. 12, 2012 (GB) 1212435.0

(51) Int. Cl. H04W 4/12

(52) U.S. Cl. CPC H04W 4/12
USPC 455/413; 455/414.1

(57) ABSTRACT

This invention provides a transcription device configured to convert an audio signal representing speech into corresponding text data. The transcription device is located on a calling party's telecommunications device or network, and, on receipt of a transcription request from a receiving party's telecommunications network, is configured to transcribe the audio signal and send the text data to the receiving party's telecommunications network. The transcription may therefore be performed locally (e.g. on a calling party's telecommunications device) before being transmitted to the receiving party's telecommunications network. The quality of the audio sample for transcribing is therefore much greater, and the accuracy of the transcription is therefore increased.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

This invention relates to a transcription device and a method for transcribing speech.

### BRIEF SUMMARY

Voice transcription is the process of converting speech into corresponding text. This process is often performed by a Speech to Text (STT) engine. STT engines often struggle to perform accurate conversions when transcribing an incoming voice sample from an unknown person, such as when transcribing a voicemail recording on a receiving party's telecommunications device. STT engines often even fail to determine reliably the language of the speaker of the voice sample. By comparison, STT engines are much more reliable at transcribing voice samples when they are able to refer to a pre-established voice profile for the speaker.

In the case of transcribing voicemail recordings, this problem is compounded by a number of factors. Firstly, voicemail recordings are typically quite short (often lasting less than a minute). The STT engine therefore only has a small number of utterances in order to assess the calling party's language and to build a voice profile. Secondly, background noise impinges on the recording of the voice, and this is highly variable between voicemail recordings. Thirdly, the audio quality is generally quite low (either toll quality or, in the case of mobile network transmission, lower than toll quality), which does not capture significant portions of the human voice spectrum.

All of these factors reduce the reliability with which STT engines can transcribe voice samples, and thus, the quality of transcription of voicemail recordings is very low. It is therefore desirable to alleviate some or all of the above problems.

According to a first aspect of the invention, there is provided a transcription device for transcribing an audio signal representing speech to text data, the device located on a calling party's telecommunications network, comprising an input configured for receiving a transcription request from a receiving party's telecommunications network; a processor configured for converting an audio signal representing speech to text data in response to the input receiving the transcription request; and an output configured for sending the text data to the receiving party's telecommunications network.

In the present invention, the transcription may therefore be performed locally and transmitted to the receiving party's telecommunications network, rather than being transcribed by the receiving party. For example, the transcription may be performed on the calling party's telecommunications device, or on a network controller on the calling party's telecommunications network. Therefore, the quality of the audio sample received by the transcription device is of much higher quality than that received by the receiving party's telecommunications network in the prior art. The accuracy of the transcription is therefore greatly improved.

The transcription device, telecommunications device or network controller may include a voice profile for the calling party. This further improves the accuracy of the transcription by the transcription device.

According to a second aspect of the invention, there is provided a method for transcribing an audio signal representing speech, the method comprising the steps of: a calling party's telecommunications network calling a receiving party's telecommunications network; the calling party's telecommunications network receiving a transcription request from the receiving party's telecommunications network; the calling party's telecommunications network transcribing an audio signal representing speech to text data in response to receiving the transcription request; and the calling party's telecommunications network sending the text data to the receiving party's telecommunications network.

According to a third aspect of the invention, there is provided a telecommunications device having a voicemail state, the device configured for receiving a call from a calling party's telecommunications network and for sending a transcription request to the calling party's telecommunications network in response to receiving a call in the voicemail state.

### BRIEF DESCRIPTION OF THE DRAWINGS

Embodiments of the invention will now be described, by way of example, and with reference to the drawings in which:

FIG. 1 is a schematic diagram of a transcription device of a first embodiment of the present invention;

FIG. 2 is a schematic diagram of the transcription device of FIG. 1 in a first telecommunications device, also showing a network and second telecommunications device;

FIG. 3 is a flow chart of a method of the first embodiment of the present invention; and

FIG. 4 is a schematic diagram of the transcription device of FIG. 1 in a network controller, also showing a first telecommunications device and a second telecommunications device.

### DETAILED DESCRIPTION

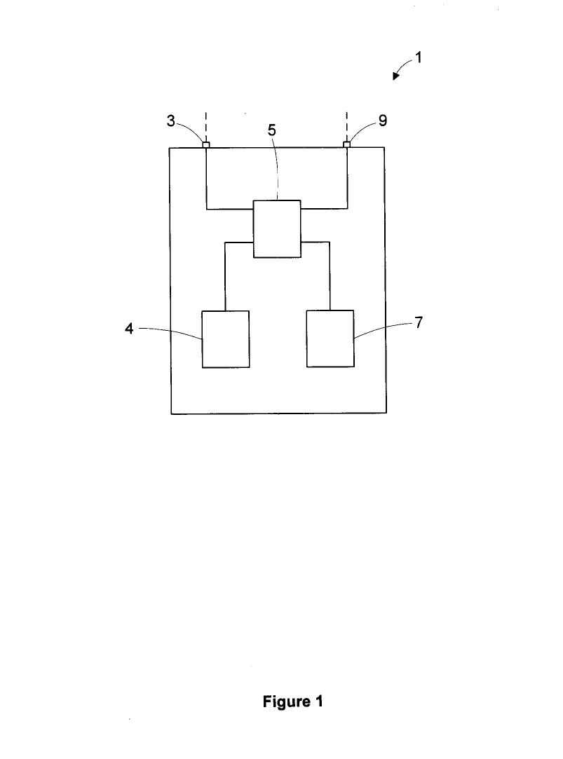

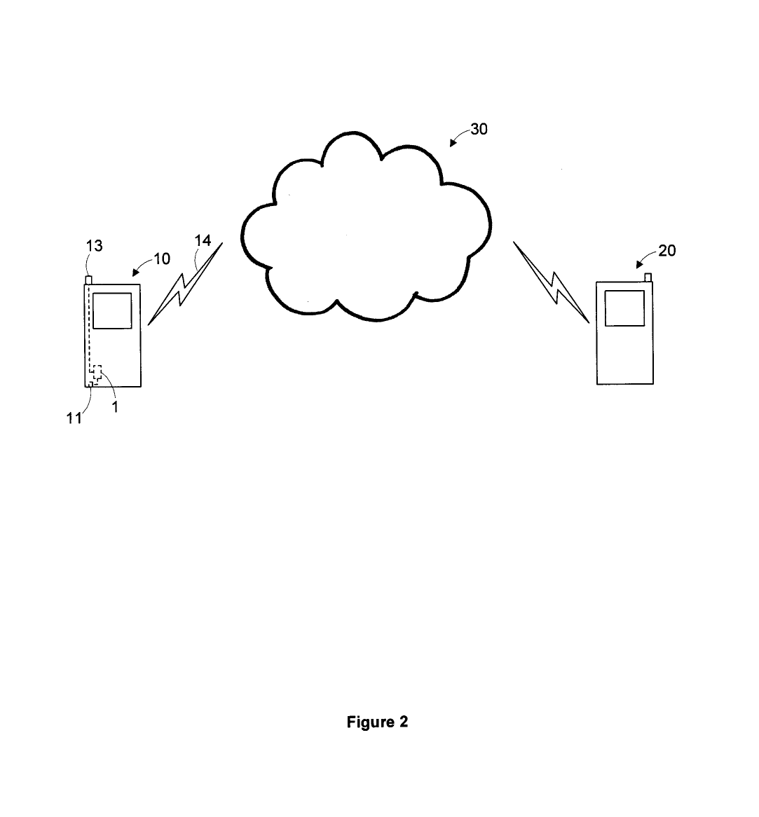

A first embodiment of a transcription module 1 of the present invention will now be described with reference to FIGS. 1 and 2. The transcription device 1 is configured to receive an audio signal containing speech at an input 3. In this embodiment, the transcription device 1 is located on a first telecommunications device 10, which includes a microphone 11 for producing the audio signal. The microphone 11 is configured to send the audio signal to the input 3 of the transcription device 1.

The transcription device 1 also includes a buffer 4, a processor 5 and storage means 7. The transcription device 1 stores the audio signal on the buffer 4, and the processor 5 is configured to convert the audio signal into corresponding text data. The processor 5 therefore employs an STT engine. The processor 5 is also connected to the storage means 7, which stores a voice profile for a user of the first telecommunications device 10. The STT engine therefore uses the voice profile for the user to improve the quality of transcription of the audio signal.

The transcription device 1 also includes an output 9. The output 9 is configured to send the text data (corresponding to the speech) over a communication link 14 from the first telecommunications device 10. The first telecommunications device 10 transmits the text data to a second telecommunications device 20, via a network 30.

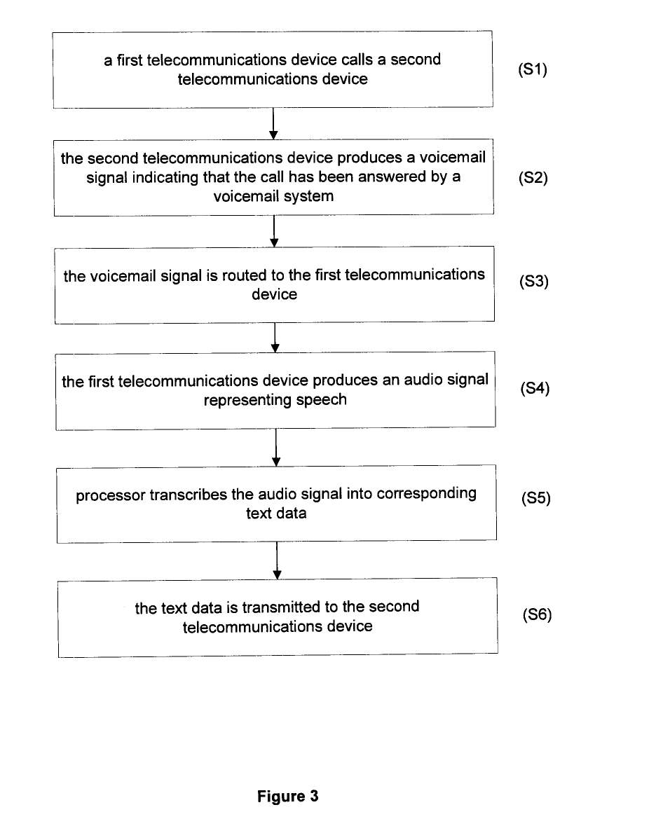

A method of the present invention will now be described with reference to FIG. 3. A calling party uses the first telecommunications device 10 and a receiving party uses the second telecommunications device 20. The first telecommunications device 10 has a voice profile of the calling party stored on the storage means 7.

The skilled person will understand that a voice profile comprises data that helps improve the accuracy of transcription by an STT engine. The data may be constructed by a calling party performing a training exercise, whereby a known set of words is spoken such that the STT engine learns the characteristics of the calling party's speech. These characteristics may then be used when subsequently transcribing an unknown set of words in a speech sample from that calling party.

As a first step, the calling party uses the first telecommunications device 10 to call the receiving party's second telecommunications device 20 (S1). The second telecommunications device 20 has a voicemail system, and determines that the call from the calling party should be routed to voicemail. The second telecommunications device 20 therefore produces a voicemail signal indicating that the call has been answered by the voicemail system (S2). The voicemail signal is routed to the first telecommunications device 10 (S3), and indicates to the first telecommunications device 10 that a transcription of a voicemail recording should be sent to the second telecommunications device 20 using embedded addressing information.

On receipt of the voicemail signal, the first telecommunications device 10 reserves appropriate resources for transcoding the content of the upcoming voicemail recording. The first telecommunications device 10 includes a mechanism for determining when the voicemail recording starts, when the voicemail recording ends, and if the calling party re-records the voicemail recording. In this embodiment, this is achieved by the second telecommunications device 20 sending voicemail start, end, and re-record signals to the first telecommunications device 10. On receipt of the voicemail start signal, the first telecommunications device 10 is configured to start recording any speech received at the microphone 11; on receipt of the voicemail end signal, the first telecommunications device 10 is configured to stop recording any speech received at the microphone 11, and store the signal representing the voicemail recording on the buffer 4 of the transcription device 1; and on receipt of the re-record signal, the first telecommunications device 10 is configured to restart recording any speech received at the microphone 11.

Thus, the first telecommunications device 10 produces an audio signal representing speech (S4), which is stored in the buffer 4. The processor 5 transcribes the audio signal into corresponding text data (S5). The text data is then transmitted to the second telecommunications device 20 using the addressing information stored within the voicemail signal (S6). The text data is transmitted via the output 9, antenna 13 and network 30. In this embodiment, the transmission uses the Voice Protocol for Internet Messaging (VPIM) standard, and also includes the audio content of the voicemail recording, such that the audio content and associated transcription may be correlated on the receiving party's voicemail system.

The skilled person will understand that the transcription device and method of the present invention greatly improves the accuracy of the transcription of the voicemail recording. As the transcription is performed before being sent to the second telecommunications device 20, the voice sample to be used by the STT engine is much improved. That is, the quality of the audio received by the microphone 11 is much better than that received by the second telecommunications device after encoding and transmission, and the calling party's telecommunications device 10 may include local noise cancellation to minimize impact of background noise. Furthermore, the STT engine uses a pre-defined voice profile for the calling party, and the calling party may indicate, through configuration data stored on the telecommunication device 10, what language he/she is talking in. This also improves the quality of the transcription.

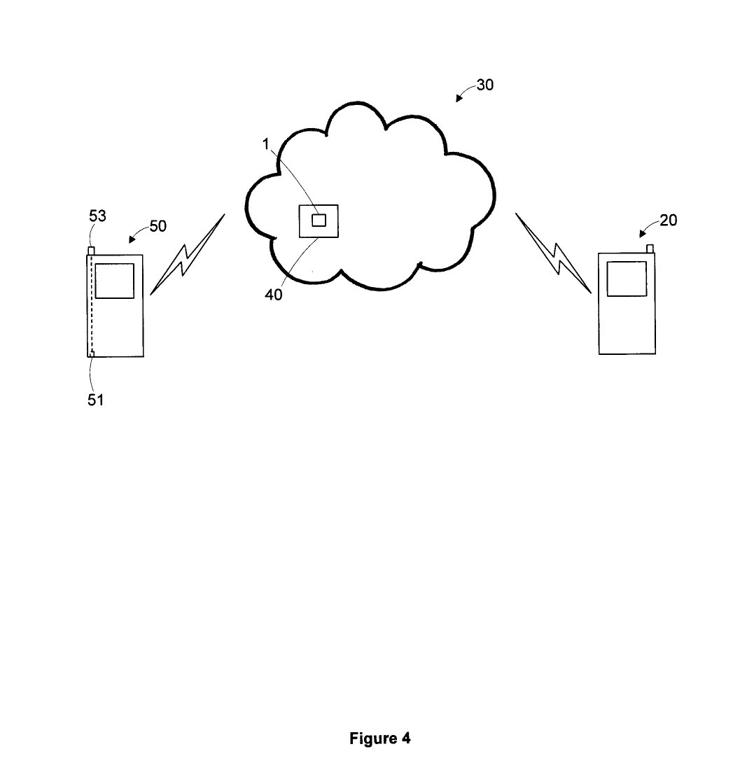

The skilled person will understand that it is not essential for the transcription device 1 to be located on the first telecommunications device 10. Rather, the transcription is performed before being sent to the second telecommunications device 20. For example, the transcription may be performed by an intermediary on the calling party's telecommunications network. The skilled person will understand that the quality of the audio signal on such a network intermediary may still be greater than that received by the second telecommunications device in the prior art, and as such, the quality of the transcription is still improved. That is, the high quality audio sample recorded on the calling party's telecommunications device may be transmitted to the network with little or no loss in audio quality, such that the transcription on the network is still of a high quality. This also has the benefit that the STT processing is off-loaded to the network, which may employ greater processing power than the calling party's telecommunications device. This example will now be described with reference to FIGS. 1 and 4.

The transcription module 1 is identical to that as described above in relation to the first embodiment (and like for like reference numerals are used). However, in this embodiment, the transcription device 1 is located on a network controller 40. The input 3 of the transcription device 1 is therefore configured to receive the audio signal from the first telecommunications device 50 over the network. The transcription device 1 is configured to send the text data to the second telecommunications device 20 or the network handling voicemail for the second telecommunications device 20.

The method of transcription in the second embodiment of the invention is substantially similar to the first embodiment described above. However, in this embodiment, the first telecommunications device 50 transmits the audio signal to the network controller 40. The network controller 40 receives the audio signal, which is then passed to the transcription device 1 via the input 3 and transcribed as described above. The text data is then sent to the second telecommunications device 20 via the output 9.

The skilled person will understand that the transcription (in either the first or second embodiment of the invention) may take place while the person is speaking (i.e. “live” or “on-the-fly”), or the voice sample may be transcribed after the recording has ended.

The skilled person will understand that it is not essential that the telecommunications devices are mobile telephones (as shown in the Figures), but may be any form of telecommunications device, e.g. landline, switch, or Voice-Over-IP enabled computing apparatus. Furthermore, the calling party's telecommunications device may be located at any point in the calling party's telecommunications network, and the receiving party's telecommunications device may be located at any point in the receiving party's telecommunications network.

The skilled person will understand that it is not essential for the transcription device to be a single module. That is, the processing and transmitting elements may be in modular form and/or shared with other parts of the telecommunications device or network controller. For example, the processor of a telecommunications device could also be configured to transcribe the audio signal, and the antenna of the telecommunications device could also be configured to transmit the text data.

The mechanism described above for recognizing the start, end, and re-recording of the voicemail recording is also not essential, and the skilled person will understand that other mechanisms are available. For example, tone-detection to detect the start of the audio and local DTMF input to detect the end of the recording may be used.

Furthermore, the skilled person will understand that it is not essential for the transcription device to include a voice profile for the calling party. However, this improves the quality of the transcription.

The skilled person will also understand that it is not essential that the text data is transmitted to the second telecommunications device 20 using the VPIM standard. That is, any suitable protocol may be used. Furthermore, it is not essential that the audio content of the voicemail recording is included.

The skilled person will also understand that the present invention has further benefits. For example, with an improved transcription of the voicemail recording, the receiving party may perform more accurate translations into their chosen language. The receiving party may also use Text-To-Speech engines on the received transcription. Furthermore, lawful intercepts of voicemail recordings may now be accompanied by interception of improved accuracy transcriptions.

The skilled person will understand that any combination of features is possible without departing from the scope of the invention, as claimed.

1. A transcription device for transcribing an audio signal representing speech to text data, the device located on a calling party's telecommunications network, comprising
an input configured for receiving a transcription request from a receiving party's telecommunications network;
a processor configured for converting an audio signal representing speech to text data in response to the input receiving the transcription request; and
an output configured for sending the text data to the receiving party's telecommunications network.

2. A transcription device as claimed in claim 1, wherein the processor utilizes a voice profile corresponding to a calling party.

3. A telecommunications device including the transcription device of claim 1, further comprising a microphone for producing the audio signal representing speech.

4. A telecommunications device including the transcription device of claim 2, further comprising a microphone for producing the audio signal representing speech.

5. A network controller including the transcription device of claim 1, wherein the input is also configured for receiving the audio signal representing speech from a calling party's telecommunications device.

6. A network controller including the transcription device of claim 2, wherein the input is also configured for receiving the audio signal representing speech from a calling party's telecommunications device.

7. A method for transcribing an audio signal representing speech, the method comprising the steps of:
a calling party's telecommunications network calling a receiving party's telecommunications network;
the calling party's telecommunications network receiving a transcription request from the receiving party's telecommunications network;
the calling party's telecommunications network transcribing an audio signal representing speech to text data in response to receiving the transcription request; and
the calling party's telecommunications network sending the text data to the receiving party's telecommunications network.

8. A method as claimed in claim 7, wherein a telecommunications device in the calling party's telecommunications network transcribes the audio signal representing speech.

9. A method as claimed in claim 7, wherein a network intermediary in the calling party's telecommunications network transcribes the audio signal representing speech.

10. A telecommunications device having a voicemail state, the device configured to send a transcription request to a calling party's telecommunications network in response to receiving a call when in the voicemail state, and adapted to receive and store a transcribed voice message.

11. (canceled)

12. (canceled)

13. (canceled)
